(19) United States
(12) Patent Application Publication
(10) Pub. No.: US 2008/0082819 A1
(43) Pub. Date: Apr. 3, 2008

(54) Authenticating data returned from non-volatile memory commands

(76) Inventors: Jack Brizek, Placerville, CA (US); Brent M. Ahlquist, Loomis, CA (US)

Correspondence Address: TROP PRUNER & HU, PC, 1616 S. VOSS ROAD, SUITE 750, HOUSTON, TX, 77057-2631, US

(21) Appl. No.: 11/529,022

(22) Filed: Sep. 28, 2006

(51) Int. Cl. H04L 9/00

(52) U.S. Cl. 713/168

(57) ABSTRACT

In some embodiments, a command may be used by a host processor to access certain information from a non-volatile memory, together with a message authentication code. That information may be utilized to generate a message authentication code on the processor. Then, in any future accesses, the message authentication code generated by the host processor may be compared to the message authentication code from the non-volatile memory to determine the integrity of data or code that is received from the non-volatile memory.

### BACKGROUND

This relates generally to enabling the authentication of information stored in non-volatile memory.

In many cases, during an initial booting of a processor-based system, the code that is available is limited. The code may be limited to information that is available on a boot read only memory (ROM). It may also be desirable to access information on a non-volatile memory, such as a flash memory, in association with the boot process. However, the host processor may know that it can trust what is in the boot ROM on board its own system, but may have no basis for having confidence in the integrity of information on an external memory.

As one possible application, a cellular telephone may have a host processor, a boot ROM, and a flash memory. The concern is that if the host, trusting data contained on the flash memory, uses that information to boot, the system could be corrupted. For example, the code in the flash might be altered by an unscrupulous user to obtain free phone service or to alter or copy the boot code.

Thus, authenticating the information on the external memory may be desirable. Generally, such authentication may take an amount of time. In the application of a phone, this may mean that, when the phone initially is turned on, it takes some amount of time for the phone to boot up and begin operating. In addition, every time it is necessary to access additional information from the non-volatile memory, an authentication protocol may be implemented which may be somewhat time consuming.

### BRIEF DESCRIPTION OF THE DRAWINGS

FIG. 1 is a schematic depiction of a processor-based system in accordance with one embodiment of the present invention;

FIG. 2 is a flow chart for one embodiment of the present invention;

FIG. 3 is a flow chart for another embodiment of the present invention;

FIG. 4 is a flow chart for another embodiment of the present invention;

FIG. 5 is a depiction of another embodiment of the present invention;

FIG. 6 is a flow chart for authenticating data returned from a non-volatile memory; and

FIG. 7 is a depiction of a non-volatile memory according to one embodiment.

### DETAILED DESCRIPTION

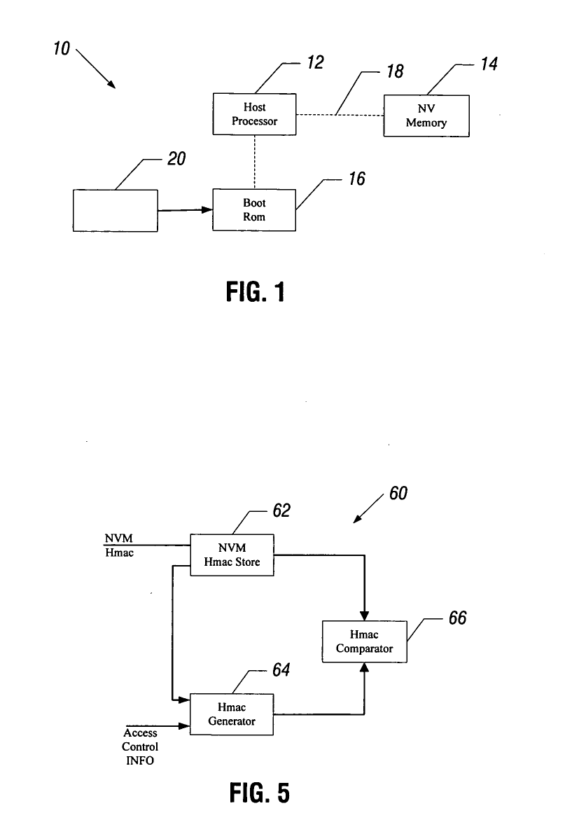

Referring to FIG. 1, a processor-based system 10 may include a host processor 12 which may be associated with a boot read only memory (ROM) 16. In one embodiment, the boot ROM 16 may be part of the same integrated circuit that includes the host processor 12. Alternatively, it may be part of the same chipset. In either case, therefore, the ROM 16 is inherently reliable. As a result, communications between the ROM 16 and the processor 12 are treated as internal communications and no authentication would normally be required. When the processor and boot ROM are embedded within the same platform, corruption or intervention by an unscrupulous user is extremely difficult.

Also coupled to the host processor 12, over a bus 18, may be a non-volatile memory 14. In one embodiment, the non-volatile memory 14 may be a flash memory. The non-volatile memory 14 may be a reprogrammable memory which is subject to being corrupted by an unscrupulous user. As one example, such a user may attempt to change the code in the memory 14 in order to obtain services to which the user would not otherwise be entitled.

Thus, in accessing information of a critical nature, the host processor 12 can generally trust information it receives from the boot ROM 16 but may not always be able to inherently trust information it receives from the non-volatile memory 14.

This inability to trust external memory may be particularly critical in the boot process wherein information may be needed that exceeds the capacity of the boot ROM 16. Such information may then need to be obtained from the memory 14 which may have a greater capacity. In addition, because the memory 14 is reprogrammable, updates may be provided to boot code or other critical code which is only accessible from the memory 14.

Ideally, an authentication protocol is implemented between the memory 14 and the host processor 12. In some embodiments, it may be desirable that that authentication protocol be as efficient as possible to reduce time delays that may otherwise be inherent in the authentication process. In addition, the amount of data that is transferred over the bus 18 may be reduced or even minimized, in some embodiments, to improve operating efficiencies.

As one example, the system 10, shown in FIG. 1, may be a cellular telephone. Update information or other boot information may be provided on the memory 14. An unscrupulous user may attempt to reprogram the memory 14 to obtain free long distance service or to alter or steal code. Thus, it is desirable to authenticate any code or data that is obtained from the memory 14.

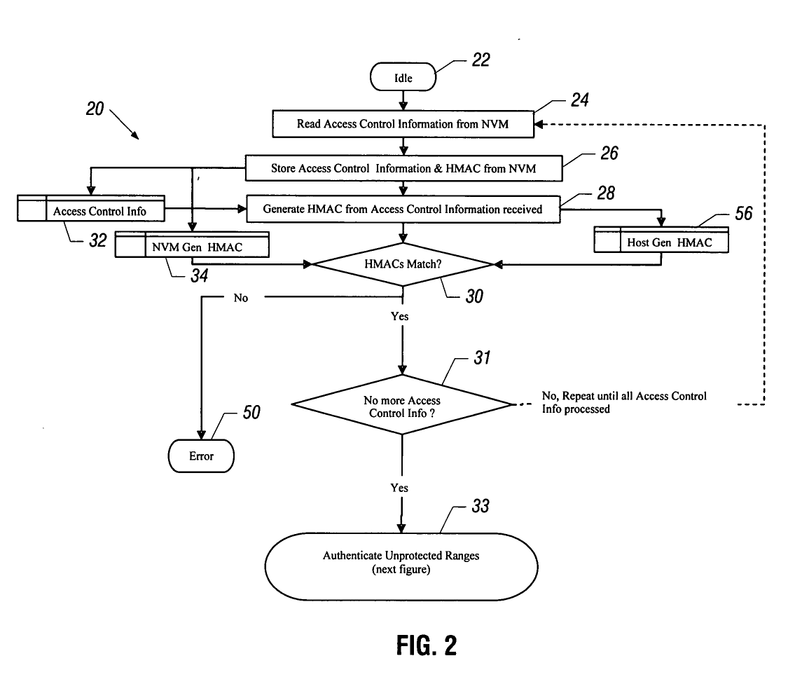

Referring to FIG. 2, an accelerated integrity check process may be implemented by the sequence 20. The flow applies when the access is directed to a protected access range that is known to be authentic, for example, because writes are prohibited or appropriately limited within that range. In some embodiments, the sequence 20 may be implemented in hardware, firmware, or software. In the case of a software implementation, the software may be stored in the boot ROM 16 (FIG. 1).

Referring again to FIG. 2, initially, after an idle period 22, the host processor 12 may read access control information from the non-volatile memory 14 as indicated in block 24. Access control information may include information about various ranges of addresses within the memory 14. It may also include information about whether particular ranges are protected. One form of protection is to require that any writes be authenticated. This results in controlling the ability of intruders to change data stored in the memory 14. In addition, the access control information may include access attributes. These may be rules for a particular memory range, about how information may be accessed in that range. For example, a particular range may require authentication to write or change that region. In addition, various associations may be included in the access control information. The associations may associate a range with a particular authentication key. Finally, tags may be included in some embodiments of the access control information which provide an identifier for referencing slots. In one embodiment, a slot is an instance that describes a range.

In order to read the access control information from the non-volatile memory, the processor 12 may know the appropriate command to obtain the access control information from the non-volatile memory. In addition, that command may be used to obtain a message authentication code such as a keyed-hash message authentication code or HMAC.

A keyed-hash message authentication code is calculated using a cryptographic hash function in combination with a secret key. It may be used to verify data integrity and the authenticity of a message. Examples of cryptographic hash functions that may be used include MD-5 or SHA-1 that are used in the calculation of the HMAC. The command may enable the host processor 12 to get an HMAC of a digest of information for each slot, one slot at a time, where each slot may be separately authenticated through an HMAC.

Thus, the access control information is obtained from the non-volatile memory, as indicated in block 24, using the appropriate command which may be stored on the host processor 12, such as in the boot ROM 16. The access control information that has just been obtained, as well as the HMAC that was just obtained, may be stored in an appropriate memory associated with the host processor 12 as indicated in block 26.

Since the access control information is stored in a publicly inaccessible control region of the non-volatile memory 14, the information need not be authenticated in some embodiments. The access control information can be stored for use by the host in determining which regions are protected and which are unprotected. Generally, when protected regions are read, authentication need not be done.

Then, the host processor 12 may generate an HMAC from the access control information 32 that was received from the non-volatile memory 14 as indicated in block 28. Next, a check at diamond 30 determines whether the HMACs generated by the host processor 12 and as received from the non-volatile memory 14 match. Specifically, the access control information is utilized to generate the new HMAC in the host processor 12 as indicated at block 56. This new HMAC 56 that is host generated is then compared to the non-volatile memory generated HMAC 34 at diamond 30. If the two separately generated HMACs fail to match, there is an authentication problem and an error is reported, as indicated at block 50. Otherwise, a check at diamond 31 determines whether there is more access control information.

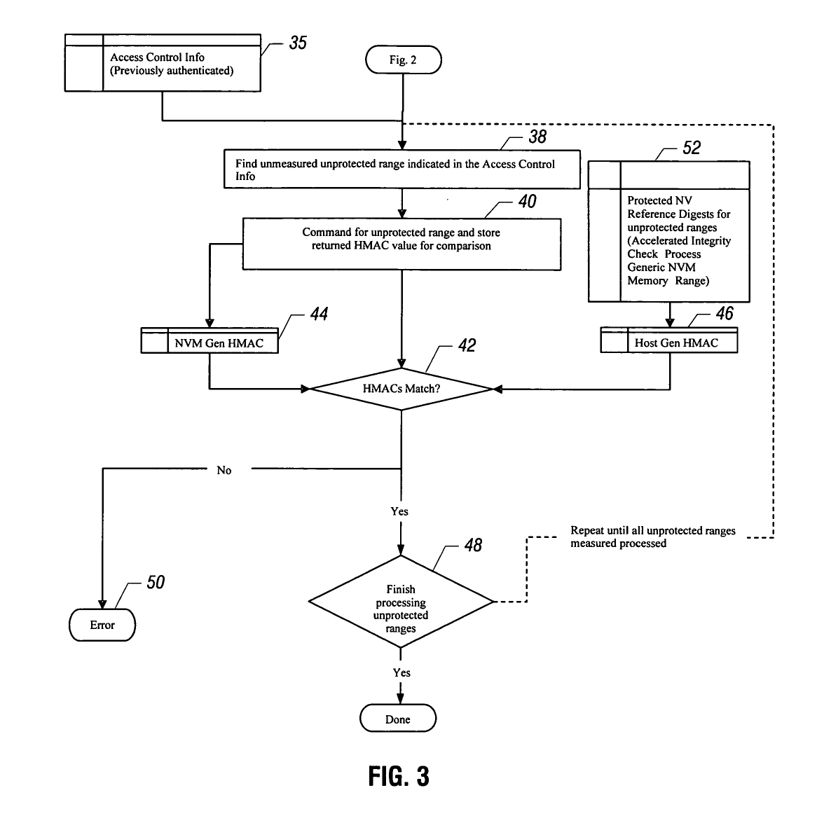

Once the access control information has been authenticated, if desired, it can be used to authenticate unprotected memory ranges (operation 33 in FIG. 2). Referring to FIG. 3, an unprotected memory range may not be protected (e.g. by precluding writes) and may not have previously been measured or subjected to an HMAC. By “measure,” it is intended to refer to the host process of reading the data again from the non-volatile memory to be sure the host received data from the memory, not from an interloper.

Starting at block 38, the subject range is located within the previously received access control information 35. A host measure range command is then executed for the correct unprotected range as indicated in block 40. Also, a returned HMAC may be stored for subsequent comparison. The memory range sample authentication is determined by comparing locally generated and received HMACs, as indicated in diamond 42, where the locally generated or host generated HMAC is the HMAC 46 and the non-volatile generated HMAC is the HMAC 44. The non-volatile generated HMAC 44 may be derived from the original access control information 35.

The protected reference digests may be estimated for the selected unprotected range (block 52). The digests are read from the non-volatile memory and may be measured to guarantee authenticity even when they come from protected regions in one embodiment. For other embodiments no authentication may be used. The digests may be used to generate the host generated HMAC 46.

Therefore, for each range, it is not necessary to again send the access control information across the memory bus 18. The sequence is repeated until the authenticity of all of the access control information and samples for each region in question is completed. The accelerated integrity check concludes trustworthiness based on information provided in the original transfer of access control information.

In some embodiments, an access control table may describe ranges of the non-volatile memory 14 and their associated keys, as well as whether or not a range of flash may be authenticated. In some ranges, no measure or authentication process may be necessary. All that the host processor needs to know is the command that will return the data from the memory 14, together with an HMAC, for the return data. The processor can check to see if the data really came from the memory 14. In such case, both the processor 12 and the memory 14 have a shared private key. The processor then knows whether it is an authenticated memory that it is dealing with and can trust what information it receives thereafter.

Normally, after a time interval from an initial measurement or authentication protocol, the host cannot be sure that the code can still be trusted. A re-check of the code integrity would be necessary, which takes additional time.

In some embodiments of the present invention, once the memory 14 has provided the HMAC and has indicated what ranges are protected, further authentication, measurements, or hash calculations can be reduced or avoided in some cases. Because the host has a digest from the original transaction of the access control information, it can use that information to determine the accuracy and reliability for subsequent accesses. For example, if a smaller range of data has already been verified, a larger range measurement can be compared to values in a table for the smaller range so that the larger range can also be quickly authenticated. This avoids the need for the host processor 12 to have to read all the data across the memory bus 18 and measure the data itself, every single time it does a measurement. Since the host processor 12 did the measurement when it downloaded (updated) the data originally, it can rely on this data and this measurement because the original data did not have to go across the memory bus. Then, the host processor 12 has the data for all future checks, reducing bus traffic.

The image of a digest table (which is smaller than all the digested or summarized data) may be written during factory programming so it is secure. As another alternative, the image may be updated in an authenticated manner by the processor during modification of the larger range. If the digest for the larger range is updated when modifications are made, the authenticated digest table measured with a measure range command, read across the memory bus and authenticated, the digest can be used to authenticate the content of the larger range representing the associated digest entry.

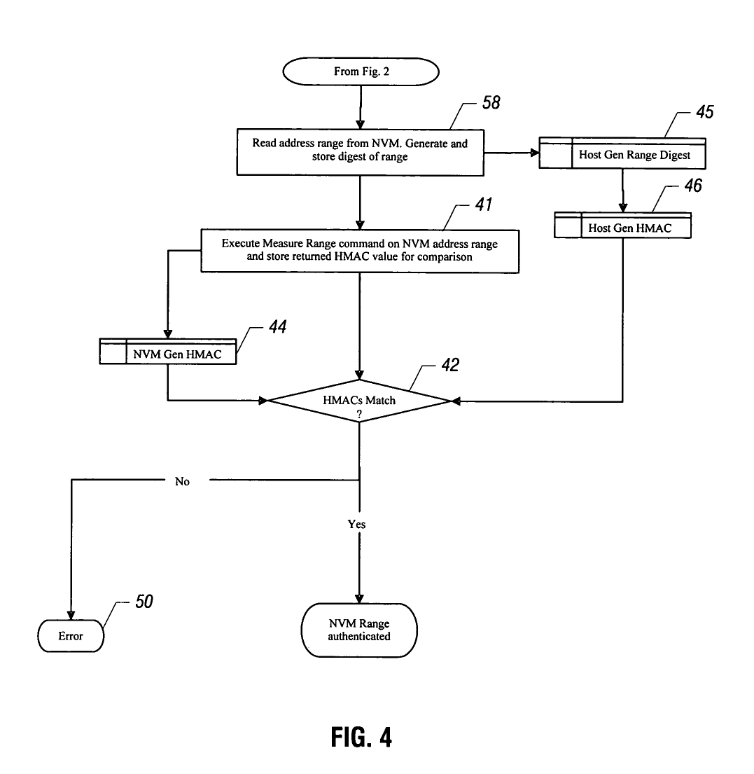

Referring to FIG. 4, an alternative flow is illustrated which, like the other flows, may be implemented in hardware, software, or firmware. The sequence may be used for both protected and unprotected ranges. In this sequence, after doing the sequence shown in FIG. 2, starting at block 58, an address range is read from the non-volatile memory and a digest of the range is stored and generated. The digest provides certain information that can be used for authentication. Necessarily, it is composed of less data than the entire address range. Thus, the digest may be more readily and efficiently transferred across the memory bus as needed. Then a host generated range is developed as indicated in block 45. Also, a host generated HMAC is developed at block 46.

In the meantime, the host executes a measure range command on the non-volatile memory address range and stores a return HMAC value for comparison (block 41). The non-volatile memory generated HMAC 44 is compared to the host generated HMAC 46 in diamond 42. If they match, the range has been authenticated. Otherwise, an error is indicated at 50.

Referring to FIG. 5, in accordance with another embodiment of the present invention, the sequence shown in FIG. 2 may be implemented in a hardware implementation. In this case, the non-volatile memory HMAC is received by a non-volatile memory HMAC store 62. It is then provided to an HMAC generator 64. The HMAC generator receives the access control information from the non-volatile memory. The non-volatile memory HMAC store 62 outputs the non-volatile memory HMAC to an HMAC comparator 66. The comparator 66 also receives the HMAC generated by the host. If the host determines that the HMAC from the non-volatile memory and the host generated HMAC match in the comparator 66, then the communication is authenticated and, otherwise, a failure is produced.

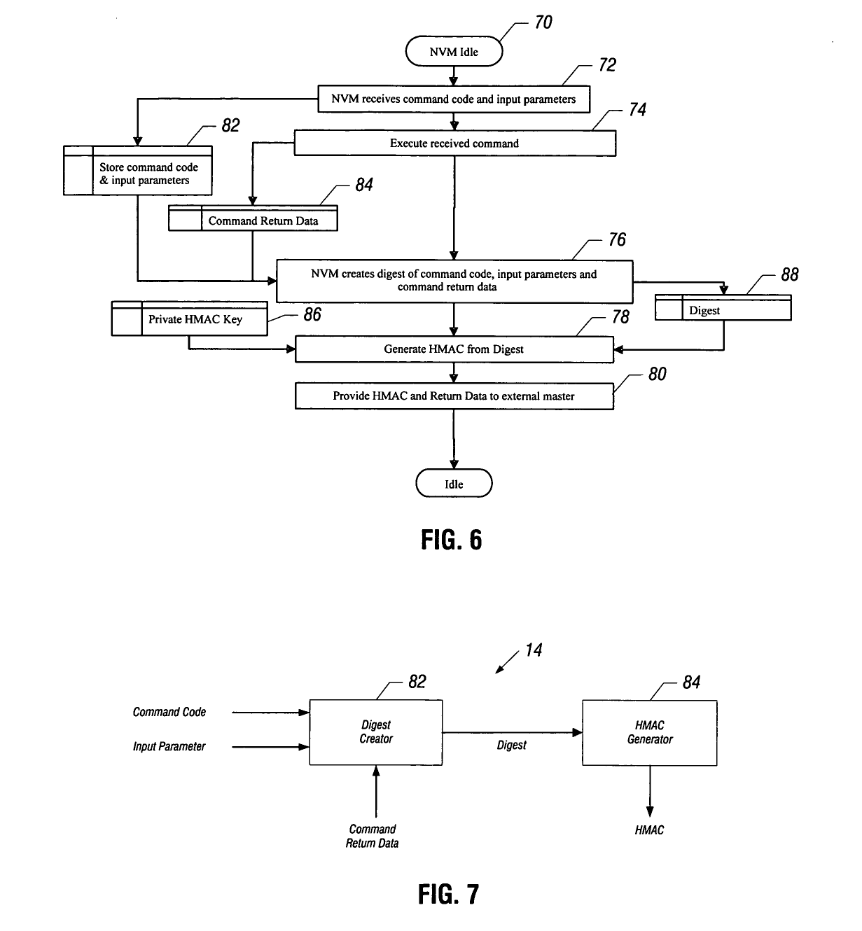

Referring to FIG. 6, on the non-volatile memory 14 side, the sequence 70 may be implemented. This sequence may be implemented in hardware, software, or firmware, as in the other cases. The sequence may be stored on the non-volatile memory 14 and may be executed thereon in one embodiment.

Initially, as indicated at block 72, the non-volatile memory 14 receives command code and input parameters from the host processor 12. While it is storing the command code and input parameters, as indicated in block 82, it may also execute the received command as indicated in block 74. It then develops the command return data which may be basically the information which the host processor 12 was seeking, as indicated in block 84.

Then, in block 76, the non-volatile memory 14 creates a digest of the command code that it received, the input parameters it received, and the command return data developed in block 84. Thus, it takes the command code and input parameters stored at block 82 and the command return data developed at block 88, and creates a digest of this information. In some embodiments, the digest may be a form of this information which is more compact and may be more readily and efficiently transported. The digest may include only that information which is needed to verify or authenticate, as well as to provide the needed return data, in one embodiment.

An HMAC is then generated from the digest, as indicated in block 78, using the digest 88 and the private HMAC key 86. Finally, the HMAC and the return data is provided to the external master or host processor 12 as indicated in block 80. If this sequence is followed and the HMAC generated and received by the host match, then the conclusion can be drawn that the return data is authentic. In some embodiments, the digest creation may be done using SHA-1.

A special command interface may be utilized to provide the command to the non-volatile memory device. A command interface, such as buffering or signaling, may be used to return the data to the host from the non-volatile memory.

Since an authenticated command return data may be provided from the non-volatile memory, this may simplify the process of trusted boot and real time non-volatile memory integrity checks. The trusted boot problem may then be resolved, in some embodiments, without the requirement of extra hardware or software at the platform level, while potentially reducing performance matrix.

Finally, referring to FIG. 7, the non-volatile memory 10 may include a digest creator 82 to create a digest from the command code and input parameters from the host, as well as command return data from the memory itself. The digest may be provided to an HMAC generator 84 that uses the digest to generate an HMAC provided to the host. The creator 82 and generator 84 may be implemented by a controller, such as a processor, in one embodiment.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
authenticating data returned to a host from a non-volatile memory in response to a host generated command.

2. The method of claim 1 including providing a digest including less than all of the information provided to the host in response to the host command, said digest sufficient for authentication.

3. The method of claim 2 including providing a digest including a portion of the received host generated command.

4. The method of claim 3 including providing a digest including a portion of input parameters received from the host.

5. The method of claim 2 including generating an authentication code from said digest.

6. The method of claim 5 including generating a keyed host message authentication code from said digest.

7. The method of claim 6 including initially providing write protection status information to a host processor.

8. The method of claim 7 including providing write protection status information only once and reusing the information thereafter.

9. The method of claim 8 including providing the access control information in response to a special command received from a host.

10. The method of claim 9 including maintaining the access control information in a limited access region within the non-volatile memory.

11. A computer readable medium storing instructions that, when executed, enable a host processor-based system to:
authenticate data returned to a host from a non-volatile memory in response to a host generated command.

12. The medium of claim 11 further storing instructions to:
provide a digest including less than all of the information provided to the host in response to the host command, said digest sufficient for authentication.

13. The medium of claim 11 further storing instructions to provide a digest including a portion of the received host generated command.

14. The medium of claim 11 further storing instructions to provide a digest including a portion of input parameters received from the host.

15. The medium of claim 12 further storing instructions to generate an authentication code from said digest.

16. The medium of claim 15 further storing instructions to generate a keyed host message authentication code form said digest.

17. A system comprising:
a host processor;
a non-volatile memory; and
a memory bus coupled between the host processor and the non-volatile memory, said memory to authenticate data returned to a host from a non-volatile memory in response to a host generated command.

18. The system of claim 17 wherein said non-volatile memory to provide a digest including less than all of the information provided to the host in response to the host command, said digest sufficient for authentication.

19. The system of claim 17 wherein said non-volatile memory to provide a digest including a portion of the received host generated command.

20. The system of claim 17 wherein said non-volatile memory to provide a digest including a portion of input parameters received from the host.

21. The system of claim 18 wherein said non-volatile memory to generate an authentication code from said digest.

22. The system of claim 21 wherein said processor to generate a keyed host message authentication code form said digest.

23. A non-volatile memory comprising:
a digest creator to create a digest from command code and input parameters received from a host as well as the command return data to be returned to the host from the memory; and
an authentication code generator to generate an authentication code from the digest.

24. The memory of claim 23 wherein said non-volatile memory to provide a digest including less than all of the information provided to the host in response to the host command, said digest sufficient for authentication.

25. The memory of claim 24 wherein said non-volatile memory to provide a digest including a portion of the received host generated command.

26. The memory of claim 23 wherein said memory is a flash memory.

27. The memory of claim 23 wherein said generator to generate a keyed host message authentication code from said digest.
